(19) United States
(12) Patent Application Publication
(10) Pub. No.: US 2010/0147250 A1
(43) Pub. Date: Jun. 17, 2010

(54) Piston for an internal combustion engine

(76) Inventors: Sascha-Oliver Boczek, Dielheim (DE); Rainer Scharp, Vaihingen (DE)

Correspondence Address: COLLARD & ROE, P.C., 1077 NORTHERN BOULEVARD, ROSLYN, NY, 11576, US

(21) Appl. No.: 12/592,091

(22) Filed: Nov. 19, 2009

(30) Foreign Application Priority Data
Dec. 13, 2008 (DE) 10 2008 062 219.2

(51) Int. Cl. F02F 3/16; F01B 31/08

(52) U.S. Cl. 123/193.6; 92/186

(57) ABSTRACT

A piston for an internal combustion engine has a piston crown and a cooling channel disposed close to the piston crown and radially on the outside. The cooling channel is delimited on the underside by ribs uniformly distributed over the circumference, with openings lying between them. The openings of the cooling channel are closed off with two metal cover sheets attached to its underside, in the shape of a half circle. There is at least one oil inflow opening and at least one oil outflow opening in or between the cover sheets.

### CROSS REFERENCE TO RELATED APPLICATIONS

Applicants claim priority under 35 U.S.C. §119 of German Application No. 10 2008 062 219.2 filed Dec. 13, 2008.

### BACKGROUND OF THE INVENTION

1. Field of the Invention

The invention relates to a piston for an internal combustion engine.

2. The Prior Art

A steel piston for an internal combustion engine is described in German Patent Application No. DE 10 2006 053 179 A1, which has a cooling channel having two or more closable openings disposed on its underside. For this purpose, a separate closure part is provided for each individual opening, which part is inserted into the corresponding opening, with a shape fit. It is a disadvantage that a plurality of closure elements is required to close off a greater number of openings, and that the shape of the closure elements must be precisely adapted to the shape of the openings in order to hermetically seal the openings.

### SUMMARY OF THE INVENTION

It is therefore an object of the invention to avoid these disadvantages. This object is accomplished according to the invention by a piston for an internal combustion engine, having a piston crown, a ring wall formed onto the underside of the piston crown, two pin bosses formed onto the underside of the piston crown, face surfaces that are set back relative to the ring wall in a direction of the piston axis, and two skirt elements that lie opposite one another and are connected with the pin bosses. There are circumferential recesses situated between the skirt elements and the ring wall, in the region of the skirt elements. A cooling channel is disposed close to the piston crown and radially on the outside, which is delimited radially on the outside by the ring wall and on the underside by ribs uniformly distributed over the circumference, with openings lying between them. The openings of the cooling channel are closed off with at least two metal cover sheets attached to its underside, in the shape of an arc. At least one oil inflow opening and at least one oil outflow opening are provided in and/or between the metal cover sheets.

According to the invention, in this way, all the openings situated on the underside of the cooling channel are closed off with two metal cover sheets in the form of half circles.

In one embodiment, the metal cover sheets are welded onto the underside of the cooling channel. In another embodiment, the metal cover sheets are screwed onto the underside of the cooling channel. In a further embodiment, the metal cover sheets have a conical shape in the relaxed state and are attached to the underside of the cooling channel under mechanical bias and have a planar shape when attached.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a section through a piston along the line I shown in FIG. 2;

FIG. 2 shows a bottom view of the piston according to FIG. 1, and

FIG. 3 shows a section through the piston along the line III in FIG. 1.

### DETAILED DESCRIPTION OF THE PREFERRED EMBODIMENT

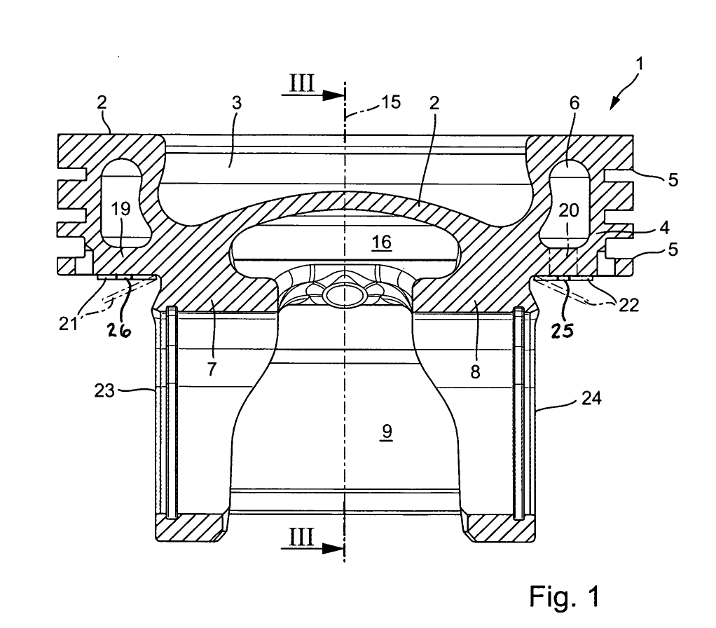

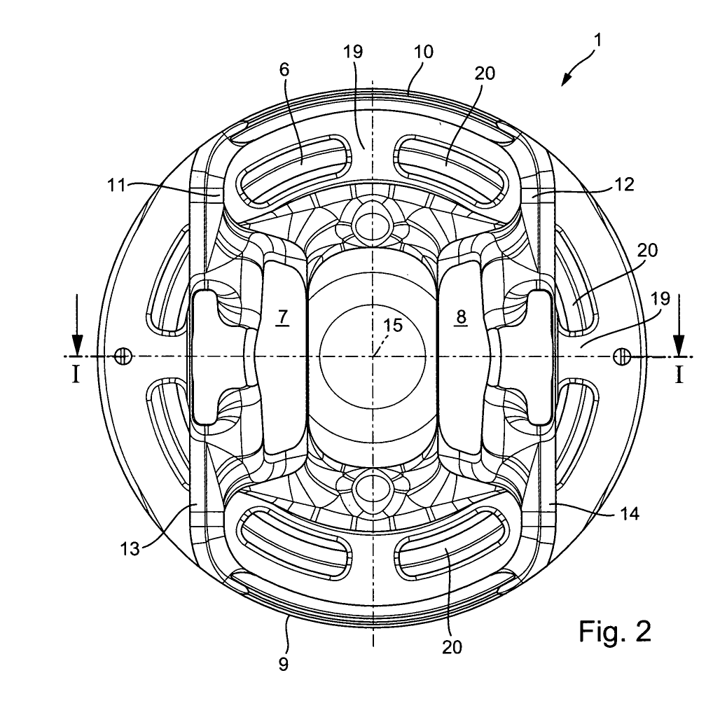

Referring now in detail to the drawings, FIG. 1 shows a piston 1 for an internal combustion engine, in section, along the line I in FIG. 2. This piston consists of steel and was produced using the casting method. However, piston 1 can also be produced from a light metal, such as aluminum or magnesium, for example. It has a piston crown 2 having a combustion bowl 3 disposed in the center, and having a ring wall 4 formed onto piston crown 2 radially on the outside, into which wall a ring belt 5 for accommodating piston pins, not shown in the drawing, is formed radially on the outside.

Piston crown 2, combustion bowl 3, and ring wall 4 delimit a circumferential cooling channel 6. Furthermore, piston 1 has two pin bosses 7 and 8 on the underside of the piston that faces away from the piston crown. Pin bosses 7, 8 have face surfaces 23, 24 that are set back relative to ring wall 4 in the direction of piston axis 15, which delimit a cavity 16 that is open toward the bottom, radially on the outside, whose upper delimitation is formed by the part of the piston crown 2 that also delimits combustion bowl 3. Pin bosses 7 and 8 are connected with one another by way of connecting walls, not shown FIG. 1, and by two skirt elements that lie opposite one another, of which the skirt element 9 is shown in FIG. 1, because of the location of the sectional plane.

The bottom view of piston 1 shown in FIG. 2 shows skirt elements 9 and 10, which are connected with pin bosses 7 and 8 by way of connecting walls 11, 12, 13, and 14 set back in the direction of piston axis 15.

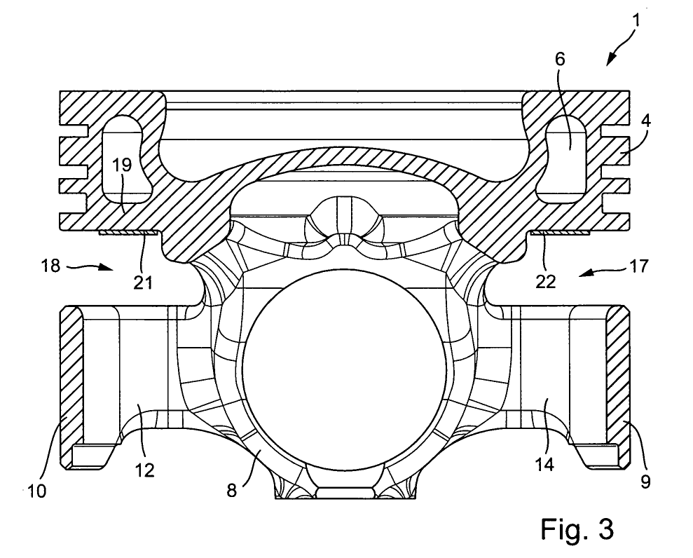

FIG. 3 shows that skirt elements 9, 10 are connected with the pin bosses 8 exclusively by way of connecting walls 12, 14, and have no direct connection with ring wall 4, for example by way of a skirt connection. Accordingly, piston 1 has recesses 17 and 18 between skirt elements 9 and 10 and ring wall 4.

On its underside, cooling channel 6 is delimited by ribs 19, which, as shown with broken lines in FIG. 1 and clearly shown in FIG. 2, lie between kidney-shaped openings 20. Ribs 19 and openings 20 are uniformly distributed over the circumference. As compared with a piston having a cooling channel that is open toward the bottom, ribs 19 increase the strength of piston crown 2 and prevent deformation of piston crown 2 during engine operation, as the result of the pressure of the combustion gases. In the production of piston 1, a lost core, for example a sand core, is used to form cooling channel 6. After completion of the casting process, it can easily be removed from the cooling channel 6 by way of the openings 20, i.e. washed out in the case of a sand core.

As FIGS. 1 and 3 show, cooling channel 6 is closed off by two metal cover sheets 21 and 22 in the shape of half circles, which are welded onto the underside of cooling channel 6 for this purpose. (In this connection, FIG. 2 shows the underside of the cooling channel 6 without the metal cover sheets.) It is also possible to attach metal cover sheets 21 and 22 to the underside of cooling channel 6 by means of screws. In FIG. 1, it is shown with a broken line that metal cover sheets 21 and 22 originally have a conical shape, before they are laid onto the ribs 19, from below, during assembly, and deformed under tension to such an extent until they assume the planar shape shown in FIGS. 1 and 3. As a result, there is a bias in the metal cover sheets 21, 22 that prevents fluttering of the metal cover sheets during engine operation, during the rapid back and forth movements of the piston 1. For passing cooling oil in and out, metal cover sheets 21, 22 have oil inflow openings 25 and oil outflow openings 26. These openings can also be situated at abutment points of the metal cover sheets. Abutment points that lie opposite one another can each have a semicircular recess that lie opposite one another in such a manner that they form a circular opening.

Accordingly, while only a few embodiments of the present invention have been shown and described, it is obvious that many changes and modifications may be made thereunto without departing from the spirit and scope of the invention.

### REFERENCE SYMBOL LIST

1 piston
2 piston crown
3 combustion bowl
4 ring wall
5 ring belt
6 cooling channel
7, 8 pin boss
9, 10 skirt element
11, 12, 13, 14 connecting wall
15 piston axis
16 cavity
17, 18 recess
19 rib
20 opening
21, 22 metal cover sheet
23, 24 face surface of the pin boss 7, 8
25 oil inflow opening
26 oil outflow opening

What is claimed is:

1. A piston for an internal combustion engine, comprising:
a piston crown;
a ring wall formed onto an underside of the piston crown;
two pin bosses formed onto an underside of the piston crown, said pin bosses having face surfaces that are set back relative to the ring wall, in a direction of a piston axis;
two skirt elements that lie opposite one another and are connected with the pin bosses, wherein circumferential recesses are situated between the skirt elements and the ring wall, in a region of the skirt elements;
a cooling channel disposed close to the piston crown, said cooling channel being delimited radially on an outside by the ring wall and on an underside by ribs uniformly distributed over a circumference of the piston, with openings lying between said ribs;
at least two metal cover sheets having the shape of an arc and being attached to an underside of the cooling channel, for closing off the openings of the cooling channel, wherein at least one oil inflow opening and at least one oil outflow opening are provided in or between the metal cover sheets.

2. The piston according to claim 1, wherein the metal cover sheets are welded onto the underside of the cooling channel.

3. The piston according to claim 1, wherein the metal cover sheets are screwed onto the underside of the cooling channel.

4. The piston according to claim 1, wherein the metal cover sheets have a conical shape in a relaxed state, are attached to the underside of the cooling channel under mechanical bias and have a planar shape after attachment.
